(19) United States
(12) Patent Application Publication
(10) Pub. No.: US 2005/0150742 A1
(43) Pub. Date: Jul. 14, 2005

(54) Coin receiver and coin separation module arrangement

(76) Inventor: Wen-Fu Yang, Taipei-City (TW)

Correspondence Address: BIRCH STEWART KOLASCH & BIRCH, PO BOX 747, FALLS CHURCH, VA, 22040-0747, US

(21) Appl. No.: 10/754,580

(22) Filed: Jan. 12, 2004

(51) Int. Cl. G07D 5/08

(52) U.S. Cl. 194/325

(57) ABSTRACT

A coin receiver and coin separation module arrangement includes a coin receiver, which has a coin passage in communication between a coin slot and a coin return, and a coin separation module defining a first coin separation passage connected to the coin passage of the receiving module, the coin separation module having a retainer, which is detachably fastened to a retainer of the receiving module to secure the coin separation module to the receiving module and a movable baffle controlled to move in and out of the first coin separation passage and to further control the running direction of coins inserted into the coin slot.

### BACKGROUND OF THE INVENTION

1. Field of the Invention

The present invention relates to vending machines and, more particularly, to a coin receiver and coin separation module arrangement for vending machine in which the coin separation module is detachably fastened to the receiving module of the coin receiver for easy maintenance.

2. Description of the Related Art

Following the development of technology, various coin-operated vending machines for vending different items (such as packaged food, beverage, or ticket vending machines, or coin exchange machines) have been disclosed, and have appeared on the market. These coin-operated vending machines commonly have a coin separator adapted to separate coins subject to their values and to guide coins of different values to different storages.

FIGS. 7 and 8 show a prior art design coin separator for this purpose. According to this design, the coin separator A comprises a lifting mechanism A1, link means A11 coupled to the lifting mechanism A1 and controlled by the lifting mechanism A1 to let inserted coin B to drop into a first coin passage A2 or a second coin passage A3. This design of coin separator has a few drawbacks as follows:

1. The first coin passage A2 and the second coin passage A3 are provided at the bottom side of the coin separators A, much machine space is needed for the coin passages. Therefore, the coin separator A requires much installation space.

2. There are multiple bonding points between the lifting mechanism A1 and the link means A11. When one bonding point loosened or broken, the link means A11 will vibrate, resulting jamming of coin in the coin slot.

3. The coin separator A is directly fixedly fastened to the coin receiver (not shown), i.e., the coin separator A is not detachable from the coin receiver. If the coin separator A fails, the coin separator A and the coin receiver must be simultaneously detached from the vending machine for repair. If the coin separator A or the coin receiver damaged, the whole assembly of the coin separator A and coin receiver must be replaced with a new one. Therefore, the maintenance work of the coin separator A is complicated, and its maintenance cost is high.

Therefore, it is desirable to provide a coin receiver that eliminates the aforesaid drawbacks.

### SUMMARY OF THE INVENTION

The present invention has been accomplished under the circumstances in view. It is the main object of the present invention to provide a coin receiver, which is detachable for easy maintenance. According to one aspect of the present invention, the coin receiver and coin separation module arrangement comprises a coin receiver, which has a coin passage in communication between a coin slot and a coin return, and a coin separation module defining a first coin separation passage connected to the coin passage of the receiving module. The coin separation module has a retainer detachably fastened to a retainer of the receiving module to secure the coin separation module to the receiving module.

According to another aspect of the present invention, the coin separation module comprises a movable baffle controlled to move in and out of the first coin separation passage and to further control the running direction of coins inserted into the coin slot of the coin receiver.

### BRIEF DESCRIPTION OF THE DRAWINGS

FIG. 1 is an elevational view of a coin separation module for a coin separator according to the present invention.

FIG. 2 is an exploded view of a coin separation module shown in FIG. 1.

FIG. 3 is an elevational view of the coin separation module and a coin receiver according to the present invention.

FIG. 4 is an elevational assembly view of FIG. 3.

FIG. 5 is a sectional side view showing the operation of the present invention (I).

FIG. 5A is a sectional side view showing the operation of the present invention (II).

FIG. 6 is a sectional front view showing the operation of the present invention (I).

FIG. 6A is a sectional front view showing the operation of the present invention (II).

FIG. 7 is a sectional side view of the prior art design (I).

FIG. 8 is a sectional side view of the prior art design (II).

### DETAILED DESCRIPTION OF THE PREFERRED EMBODIMENT

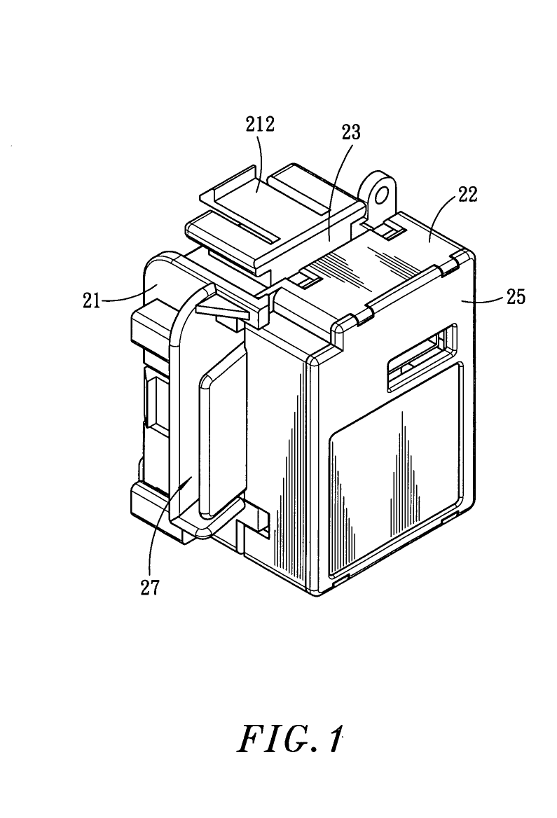

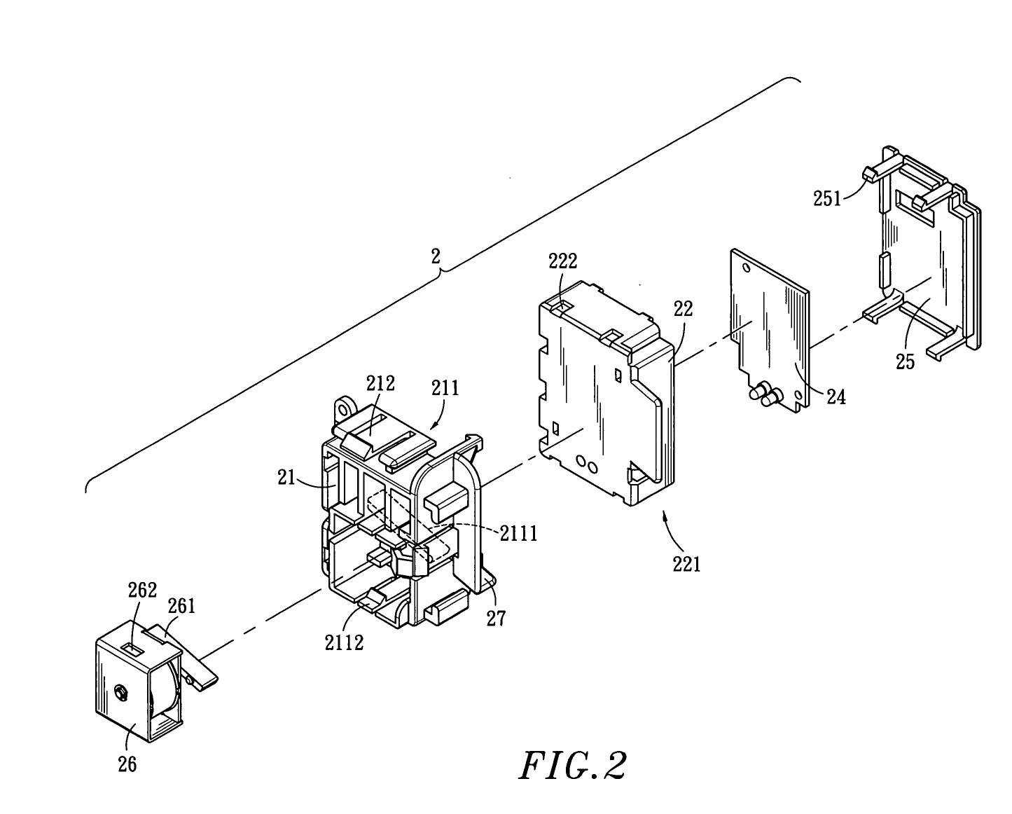

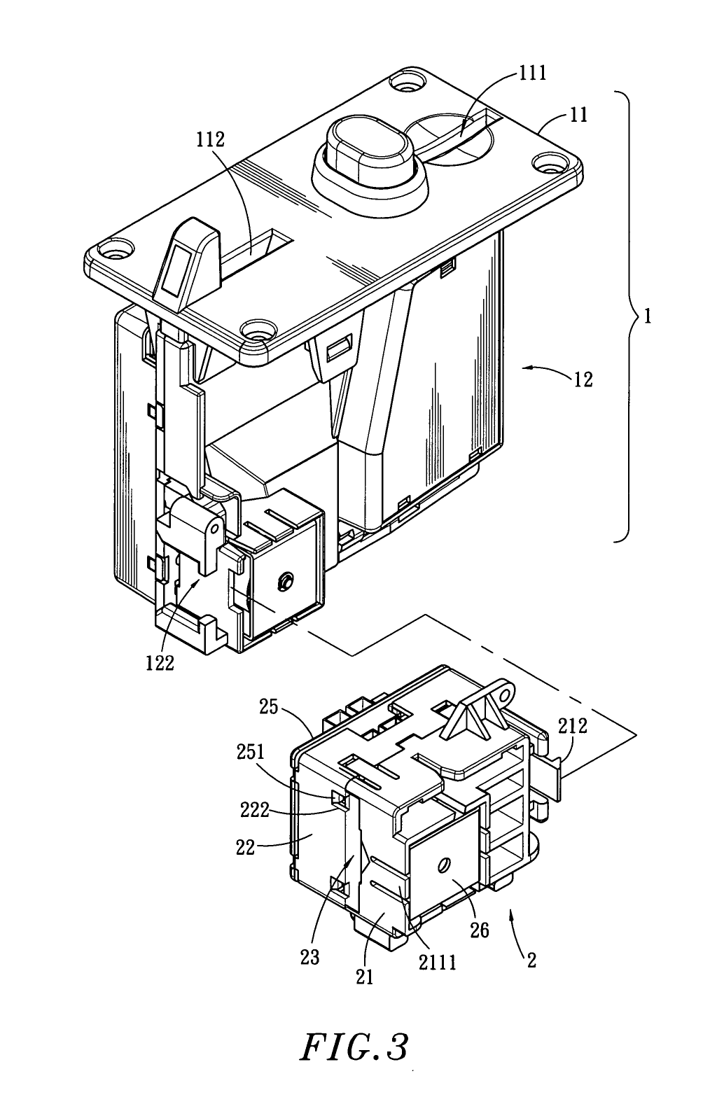

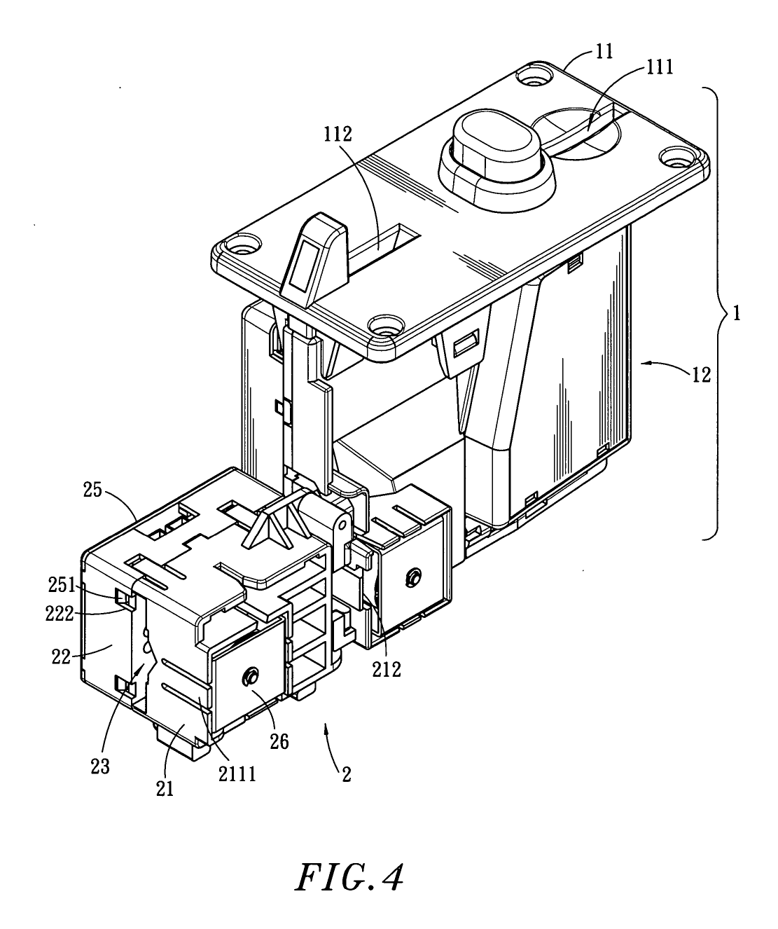

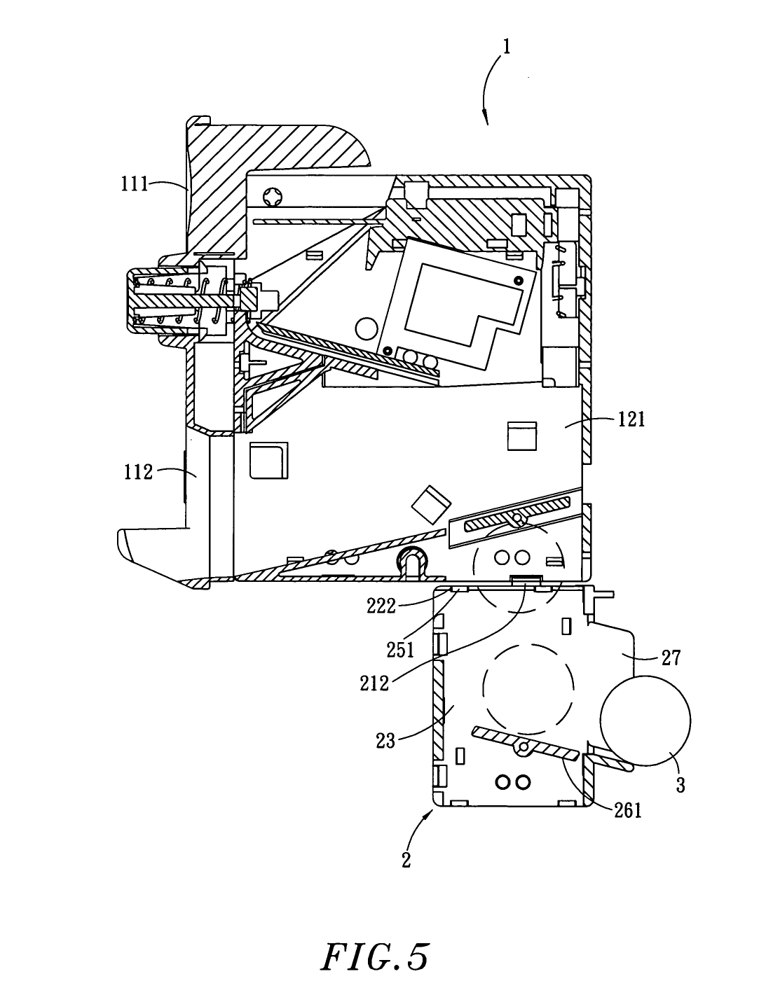

Referring to FIGS. 1˜4, a coin receiver and coin separation module is shown comprised of a coin receiver 1 and a coin separation module 2.

The coin receiver 1 comprises a face panel 11, which has a coin slot 111 and a coin-return 112, and a receiving module 12 provided at the back side of the face panel 11. The receiving module 12 comprises a coin passage 121 in communication between the coin slot 111 and the coin return 112, and a retainer 122 at the bottom side.

The coin separation module 2 comprises a first casing 21 defining an inside receiving space 211, a second casing 22 attached to one side of the first casing 21 and defining an inside receiving space 221, a first coin separation passage 23 defined in between the first casing 21 and the second casing 22, a detection module 24 mounted in the inside receiving space 221 of the second casing 22, a side cover 25 covering the inside receiving space 221 of the second casing 22, the side cover 25, and an actuation module 26 mounted in the inside receiving space 211 of the first casing 21. The second casing 22 has a plurality of retaining notches 22 around the periphery. The side cover 25 has a plurality of hooks 251 respectively hooked in the retaining notches 222 of the second casing 22. The actuation module 26 comprises a movable baffle 261 inserted through a hole 2111 in the first casing 21 into the first coin separation passage 23. The first casing 21 further comprises a plurality of hooks 2112 respectively hooked in respective retaining notches 262 is the actuation module 26 to secure the actuation module 26 to the first casing 21, and a retainer 212 disposed at the top side. Further, a second coin separation passage 27 is defined in the first casing 21 and the second casing 22 at one side in communication with the first coin separation passage 23.

The retainer 212 of the first casing 21 of the coin separation module 2 is forced into engagement with the retainer 122 of the receiving module 12 of the coin receiver 1, keeping the first coin separation passage 23 connected to the coin passage 121 of the receiving module 12.

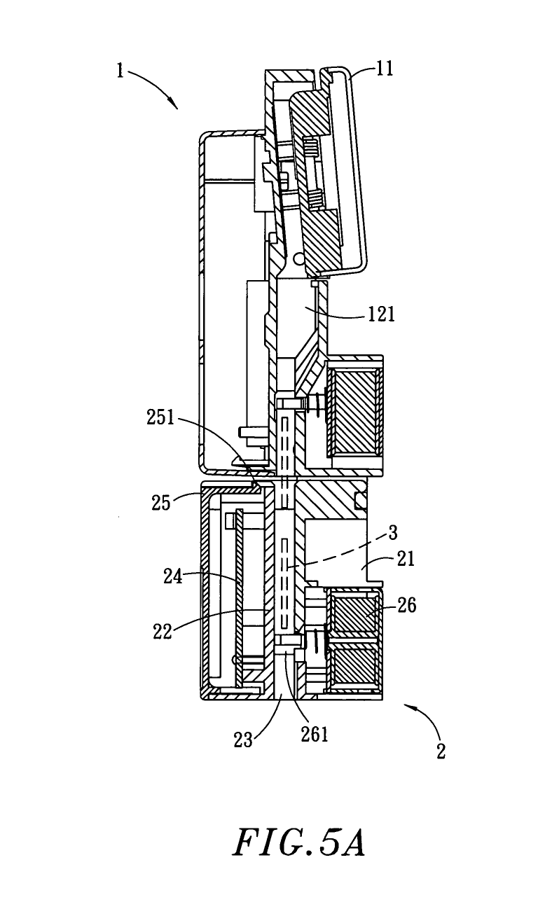

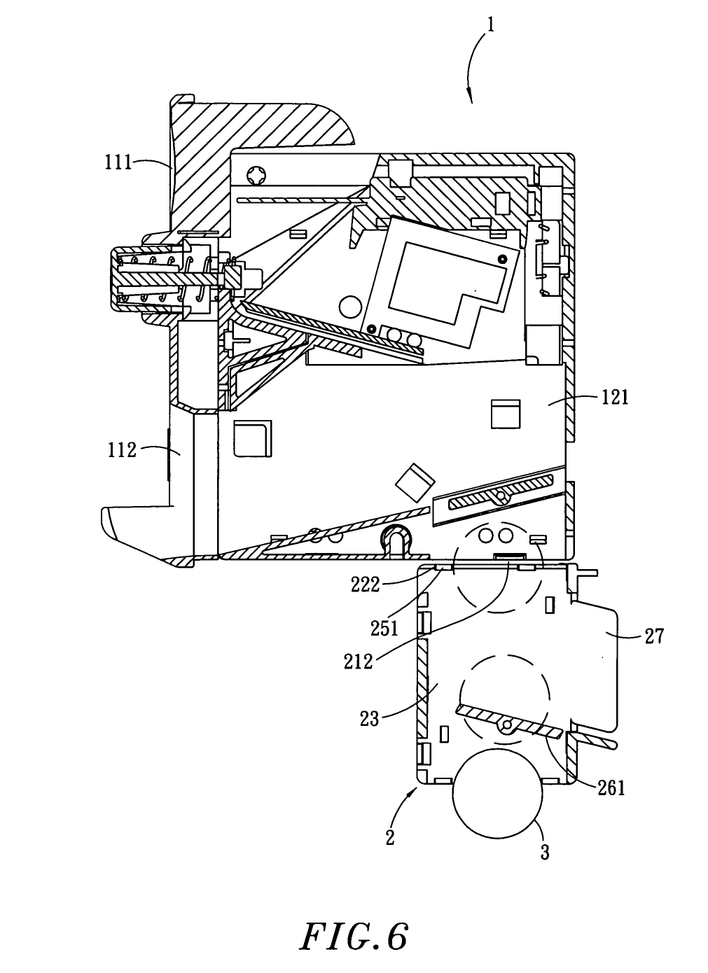

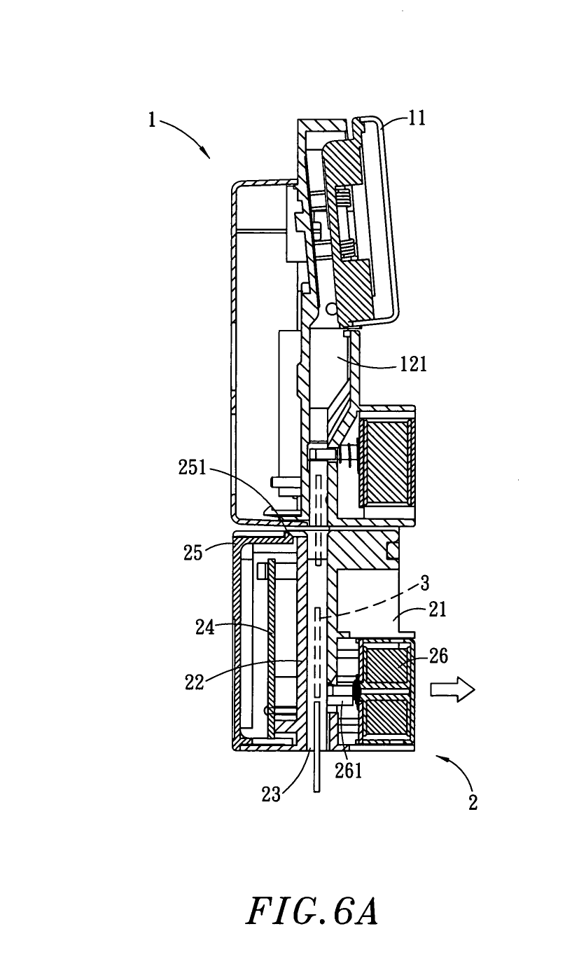

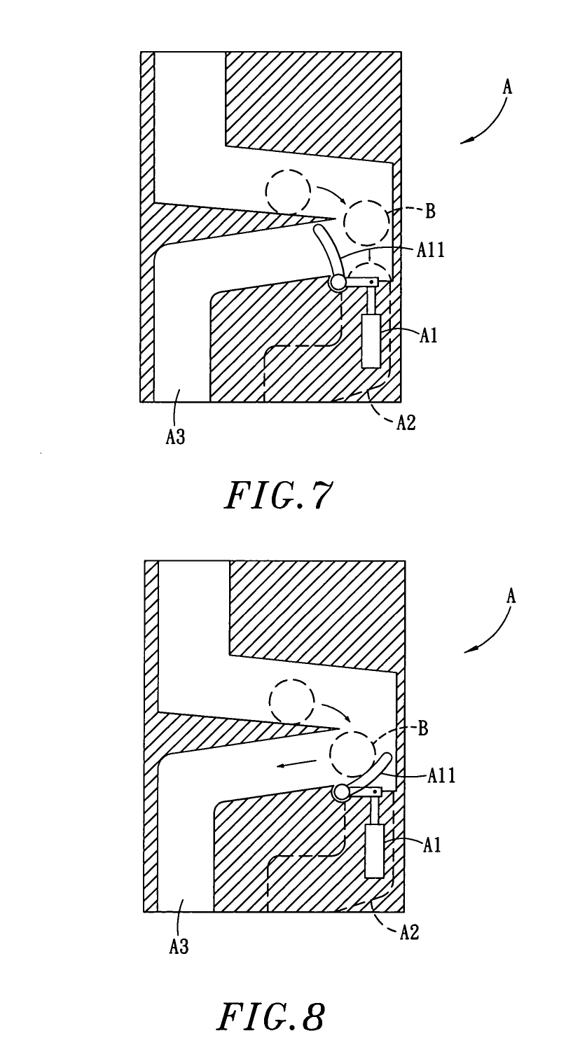

Referring to FIGS. 5, 5A, 6, and 6A, when a coin 3 inserted through the coin slot 111 in the face panel 11 of the coin receiver 1 into the coin passage 121 of the receiving module 12, the inserted coin 3 immediately runs from the coin passage 121 into the first coin separation passage 23 in the coin separation module 2. At this time, the detection module 24 of the coin separation module 2 detects the presence of the coin 3 and then gives a first signal to the actuation module 26, thereby causing the actuating module 26 to move the movable baffle 261 into the first coin separation passage 23, for enabling the coin 3 to be guided by the movable baffle 261 into the second coin separation passage 27. When the actuation module 26 receives a second signal from the detection module 24, is moves the movable baffle 261 back to the inside of the receiving space 211 of the first casing 21, for enabling the coin 3 to directly pass to the bottom side of the first coin separation passage 23.

The aforesaid actuation module 26 can be an electromagnetic switch. The coin separation module 2 can be directly detached from the coin receiver for maintenance for repair.

A prototype of coin receiver and coin separation module arrangement has been constructed with the features of FIGS. 1˜6. The coin receiver and coin separation module arrangement functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. A coin receiver and coin separation module arrangement comprising:
a coin receiver, said coin receiver comprising a face panel, said face panel having a coin slot and a coin-return, and a receiving module provided at a back side of said face panel, said receiving module comprising a coin passage in communication between said coin slot and said coin return; and
a coin separation module fastened to said coin receiver, said coin separation module comprising a first coin separation passage connected to the coin passage of said receiving module;
wherein said receiving module comprises a retainer provided at a bottom side thereof;
said coin separation module comprises a retainer detachably fastened to the retainer of said receiving module to secure said coin separation module to said receiving module, and a movable baffle controlled to move in and out of said first coin separation passage and to further control the running direction of coins inserted into said coin slot.

2. The coin receiver and coin separation module arrangement as claimed in claim 1, wherein said coin separation module further comprises a first casing, said first casing defining an inside receiving space and having a hole in communication between the inside receiving space of said first casing and said first coin separation passage for the passing of said movable baffle of said actuation module, a second casing fastened to one side of said first casing, said second casing defining an inside receiving space, said first casing and said second casing defining in there between said first coin separation passage, and a detection module mounted in the inside receiving space of said second casing; said actuation module is mounted in the inside receiving space of said first casing and controlled by said detection module to move said movable baffle in and out of said first coin separation passage.

3. The coin receiver and coin separation module arrangement as claimed in claim 2, wherein said second casing comprises a plurality of retaining notches disposed around the periphery; said coin separation module further comprises a side cover covering the inside receiving space of said second casing to hold said detection module inside said second casing, said side cover comprising a plurality of hooks respectively hooked in the retaining notches of said second casing.

4. The coin receiver and coin separation module arrangement as claimed in claim 2, wherein said actuation module comprises a plurality of retaining notches disposed around the periphery; said first casing comprises a plurality of hooks respectively hooked in the retaining notches of said actuation module.

5. The coin receiver and coin separation module arrangement as claimed in claim 2, wherein said coin separation module further comprises a second coin separation passage formed in said first casing and said second casing at one side and connected to said first coin separation passage.

6. The coin receiver and coin separation module arrangement as claimed in claim 1, wherein said actuation module is an electromagnetic switch.
